(19) United States
(12) Patent Application Publication
(10) Pub. No.: US 2021/0387313 A1
(43) Pub. Date: Dec. 16, 2021

(54) RATCHET WRENCH

(71) Applicant: Yi-Min Li, Taichung (TW)

(72) Inventor: Yi-Min Li, Taichung (TW)

(21) Appl. No.: 16/898,397

(22) Filed: Jun. 10, 2020

(51) Int. Cl. B25B 13/46; B25B 23/00

(52) U.S. Cl. CPC B25B 13/463; B25B 23/0007

(57) ABSTRACT

A ratchet wrench includes a box, a gear, a pawl, a rotor and a switch. The box includes a gear chamber, a switch chamber and a pawl chamber through which the gear chamber is in communication with the switch chamber. The pawl chamber includes a ceiling, a wall and a chamfer extending between the ceiling and the wall. The gear is inserted in the gear chamber. The pawl is inserted in the pawl chamber and engaged with the gear. The pawl includes an upper face for contact with the ceiling, a rear face or contact with the wall and a chamfer in contact with the chamfer of the pawl chamber. The rotor is inserted in the switch chamber, and includes a connective portion. The switch is inserted in the switch chamber, and includes a connective portion connected to the connective portion of the rotor.

### BACKGROUND OF INVENTION

### 1. Field of Invention

The present invention relates to a wrench and, more particularly, to a ratchet wrench.

### 2. Related Prior Art

Referring to FIGS. 5 and 6, a conventional ratchet wrench includes a handle (not numbered), a cover 20, a gear 30, a pawl 40 and a switch 60. The handle includes a shank 12 and a box 16.

The box 16 includes a gear chamber 11, a switch chamber 13 and a pawl chamber 15. The pawl chamber 15 is defined by a ceiling 17 and a wall 18. There is a corner of about 90 degrees between the ceiling 17 and the wall 18.

The gear 30 is inserted in the gear chamber 11. The pawl 40 is inserted in the pawl chamber 15. The switch 60 is inserted in the switch chamber 13. The pawl 40 is engaged with or disengaged from the gear 30 in operation. The cover 20 is secured to the box 16 to keep the gear 30, the pawl 40 and the switch 60 in the box 16.

The pawl 40 includes a cutout 44 in a substantially convex side and two blocks 46 are formed at two opposite ends of the pawl 40. Each block 46 includes an upper face 47, a rear face 48 and a corner of about 90 degrees between the upper and rear faces 47 and 48.

The switch 60 includes an axle 64, a lever 66 and a crank 54. The axle 64 radially extends from an upper portion of the switch 60. The lever 66 extends from the upper portion of the switch 60 in a radial direction. The crank 54 extends from a lower portion of the switch 60 in a radial direction. The crank 54 is movably inserted in the cutout 44. The axle 64 is inserted in the switch chamber 13. The lever 66 is operable to pivot the entire switch 60. Accordingly, the crank 54 abuts one of the blocks 46 to move the pawl 40 to one of two positions.

This conventional ratchet wrench is operable to drive a threaded bolt for example. However, there is a problem with the making of this conventional ratchet wrench. It is difficult to mold the switch 60, which includes the lever 66 and the crank 54. There is also a problem with the use of this conventional ratchet wrench. Each block 46 is vulnerable to concentration of stress due to the existence of the corner of about 90 degrees between the upper and rear faces 47 and 48.

The present invention is therefore intended to obviate or at least alleviate the problems encountered in prior art.

### SUMMARY OF INVENTION

It is the primary objective of the present invention to provide a convenient and reliable ratchet wrench.

To achieve the foregoing objective, the ratchet wrench includes a box, a gear, a pawl, a rotor and a switch. The box includes a gear chamber, a switch chamber and a pawl chamber through which the gear chamber is in communication with the switch chamber. The pawl chamber includes a ceiling, a wall and a chamfer extending between the ceiling and the wall. The gear is inserted in the gear chamber. The pawl is inserted in the pawl chamber and engaged with the gear. The pawl includes an upper face for contact with the ceiling, a rear face or contact with the wall and a chamfer in contact with the chamfer of the pawl chamber. The rotor is inserted in the switch chamber, and includes a connective portion. The switch is inserted in the switch chamber, and includes a connective portion connected to the connective portion of the rotor.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a ratchet wrench according to the preferred embodiment of the present invention;

FIG. 2 is a partial exploded view of the ratchet wrench shown in FIG. 1;

FIG. 3 is a cross-sectional view of the ratchet wrench of FIG. 2;

FIG. 4 is another cross-sectional view of the ratchet wrench taken along a line A-A shown in FIG. 3;

FIG. 5 is a partial exploded view of a conventional ratchet wrench; and

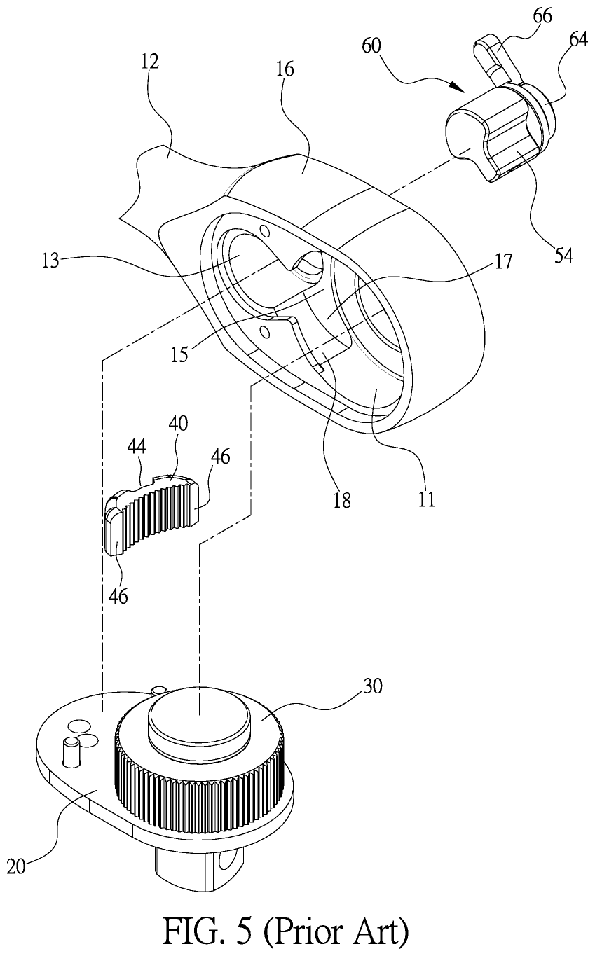

FIG. 6 is a cross-sectional view of the conventional ratchet wrench shown in FIG. 5.

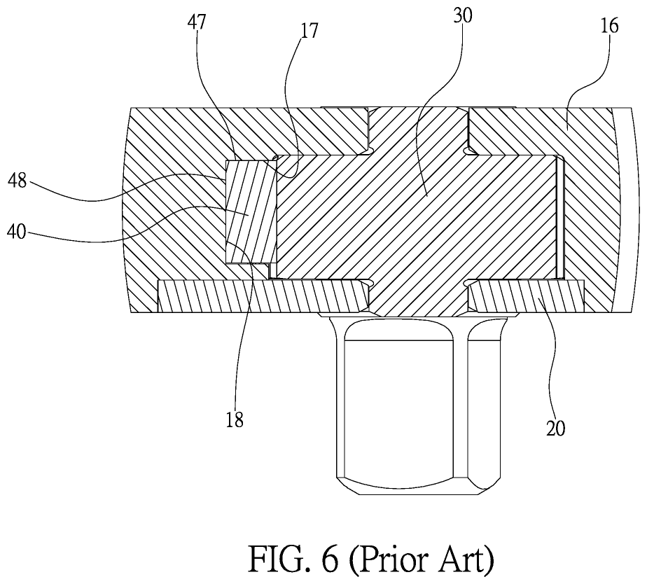

### DETAILED DESCRIPTION OF PREFERRED EMBODIMENT

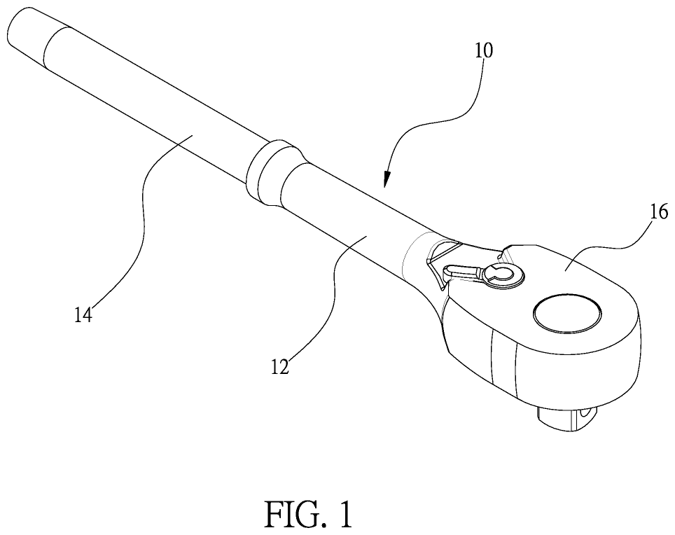

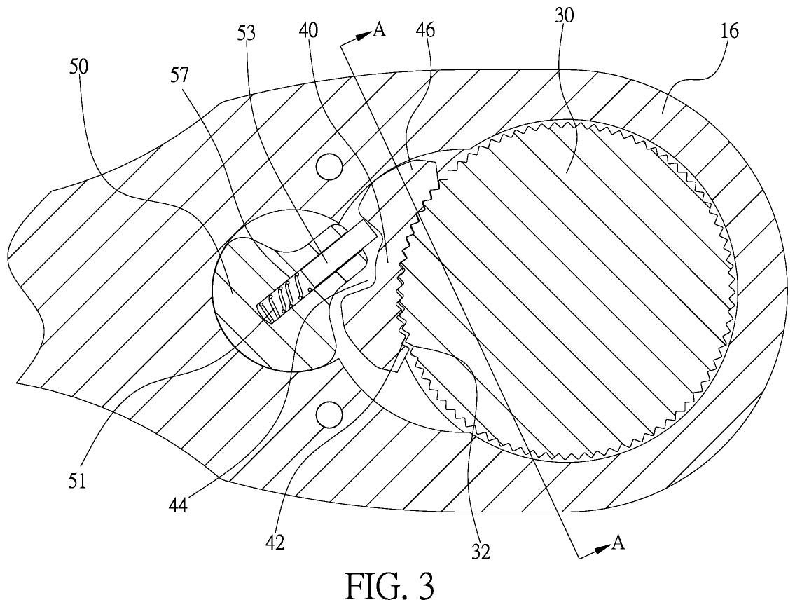

Referring to FIGS. 1 through 3, a ratchet wrench 10 includes a handle (not numbered), a cover 20, a gear 30, a pawl 40 and a direction controller (not numbered) in accordance with the preferred embodiment of the present invention. The handle includes a shank 12 formed between a grip 14 and a hollow head or box 16. The shank 12, the grip 14 and the box 16 are made in one piece. The grip 14 is operable to pivot the box 16 via the shank 12, thereby rotating a threaded bolt or a nut for example.

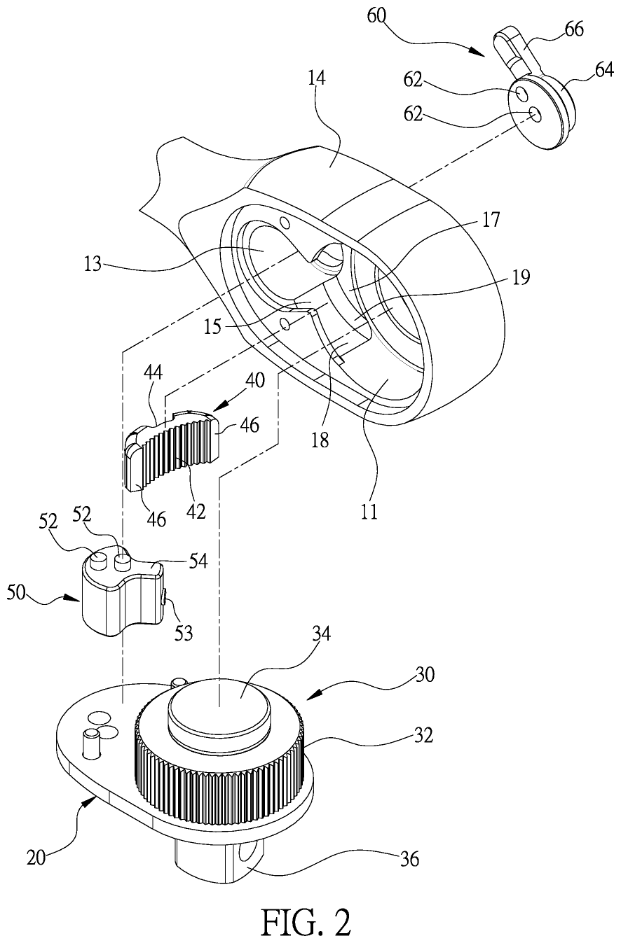

Referring to FIG. 2, the gear 30 and the pawl 40 and the direction controller are inserted in the box 16. The cover 20 is secured to the box 16 by fasteners such as screws and rivets (not shown) to keep the gear 30, the pawl 40 and the direction controller in the box 16.

The box 16 is formed with a lower face (not numbered), an upper face (not numbered), a gear chamber 11, a switch chamber 13 and a pawl chamber 15. The cover 20 is attached to the lower face of the box 16. The gear chamber 11 is a circular chamber that includes a lower open end in the lower face of the box 16 and an upper open end in the upper face of the same. The upper open end of the gear chamber 11 is made with a diameter smaller than that of the lower open end of the same. The switch chamber 13 is a circular chamber that includes a lower open end in the lower face of the box 16 and an open upper end in the upper face of the same. The upper open end of the switch chamber 13 is made with a diameter smaller than that of the lower open end of the same. The pawl chamber 15 is a crescent chamber that includes a closed upper end at the upper face of the box 16 and an open lower end in the lower face of the box 16. The pawl chamber 15 is in communication with the gear chamber 11 on a side and in communication with the switch chamber 13 on another side. The pawl chamber 15 is defined by a ceiling 17, a wall 18 and a chamfer 19. The chamfer 19 extends between the ceiling 17 and the wall 18.

The gear 30 is formed with teeth 32, an axle 34 and a square insert 36. The teeth 32 are formed on the periphery of the gear 30. The axle 34 extends from an upper face of the gear 30. The square insert 36 extends from a lower face of the gear 30.

The gear 30 is rotationally inserted in the gear chamber 11. The axle 34 extends from the gear chamber 11 through the upper open end of the gear chamber 11. The square insert 36 extends from the gear chamber 11 through the lower open end of the gear chamber 11 and an opening (not shown) made in the cover 20.

The pawl 40 is formed with a concave side (not numbered) and a substantially convex side (not numbered). Teeth 42 are formed on the concave side of the pawl 40. A cutout 44 is made in the substantially convex side of the pawl 40. The cutout 44 includes two ends (not numbered). Two blocks 46 are formed at two opposite ends of the pawl 40. The cutout 44 is located between the blocks 46.

The pawl 40 is movably inserted in the pawl chamber 15. The teeth 42 are engaged with the teeth 32.

The direction controller includes a rotor 50 and a switch 60. The rotor 50 includes two connective portions 52 and a crank 54. The connective portions 52 are preferably bosses formed on an upper face of the rotor 50. The crank 54 extends from a front face of the rotor 50.

The rotor 50 is pivotally inserted in the switch chamber 13. The bosses 52 are inserted in the upper open end of the switch chamber 13. The crank 54 is movably inserted in the cutout 44.

Preferably, the direction controller further includes a spring 51 and a rod 53. The spring 51 is inserted in a cavity 57 made in the crank 54 so that a rear end of the spring 51 is abutted against a closed end of the cavity 57. The rod 53 includes a rear end abutted against a front end of the spring 51 and a front end extending from the cavity 57 through an open end of the cavity 57. The front end of the rod 53 is movably inserted in the cutout 44. The front end of the rod 53 is abutted against one of the ends of the cutout 44 to move the pawl 40 to one of two positions.

The switch 60 includes two connective portions 62, an axle 64 and a lever 66. The connective portions 62 are preferably recesses made in a lower face of the switch 60. The axle 64 extends from an upper face of the switch 60. The lever 66 extends from the periphery of the switch 60.

The switch 60 is pivotally inserted in the switch chamber 13 so that the axle 64 extends from the switch chamber 13 through the upper open end of the switch chamber 13. The recesses 62 receive the bosses 52 so that the switch 60 is operable to pivot the rotor 50. The lever 66 is operable to pivot the switch 60.

The rotor 50 and the switch 60 are not made in one piece. Therefore, the rotor 50 and the switch 60 are molded easily, and then connected to each other without causing much trouble.

In the preferred embodiment, the rotor 50 is formed with the bosses 52 and the switch 60 is formed with the recesses 62. However, in another embodiment, the rotor 50 can be formed with recesses and the switch 60 is formed with bosses inserted in the recesses of the rotor 50.

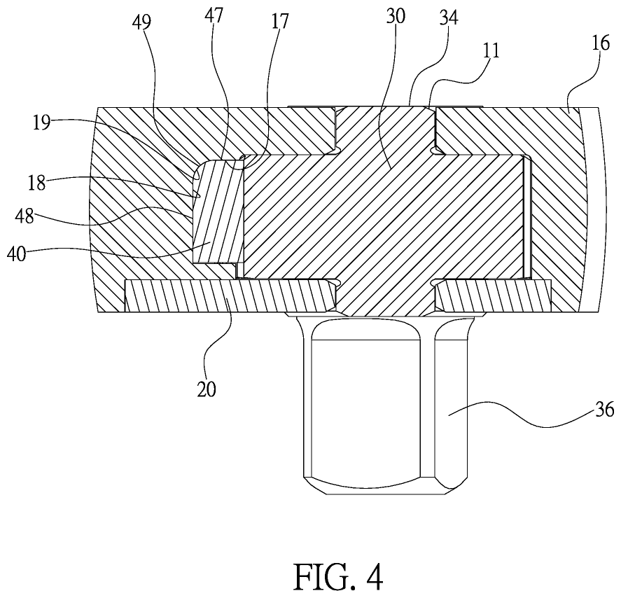

Referring to FIG. 4, each of the blocks 46 includes an upper face 47, a rear face 48 and a chamfer 49 according to the preferred embodiment of the present invention. The chamfer 49 extends along an arched edge that is formed by the upper face 47 and the rear face 48.

The upper face 47 of each block 46 is allowed to contact with the ceiling 17 of the pawl chamber 15. The rear face 48 of each block 46 is allowed to contact with the wall 18 of the pawl chamber 15. The chamfer 49 of each block 46 is allowed to contact with the chamfer 19 of the pawl chamber 15. Thus, the contact of the chamfer 49 of each block 46 with the chamfer 19 of the pawl chamber 15 protects each block 46 from concentration of stress which would otherwise be inevitable if there was a corner between the upper and rear faces 47 and 48 of each block 46.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A ratchet wrench comprising:
a box comprising a gear chamber, a switch chamber and a pawl chamber through which the gear chamber is in communication with the switch chamber, wherein the pawl chamber comprises a ceiling, a wall and a chamfer extending between the ceiling and the wall;
a gear inserted in the gear chamber;
a pawl inserted in the pawl chamber and engaged with the gear, wherein the pawl comprises an upper face for contact with the ceiling, a rear face for contact with the wall and a chamfer in contact with the chamfer of the pawl chamber;
a rotor inserted in the switch chamber, wherein the rotor comprises a connective portion; and
a switch inserted in the switch chamber, wherein the switch comprises a connective portion connected to the connective portion of the rotor.

2. The ratchet wrench according to claim 1, wherein the connective portion of the rotor comprises an element selected from the group consisting of a boss and a recess, and the connective portion of the switch comprises an element selected from the group consisting of a recess and a boss to receive or extend into the connective portion of the rotor.

3. The ratchet wrench according to claim 2, wherein the connective portion of the rotor comprises at least one boss, and the connective portion of the switch comprises at least one recess for receiving the boss of the rotor.

4. The ratchet wrench according to claim 3, wherein the connective portion of the rotor comprises two bosses, and the connective portion of the switch comprises two recesses for receiving the bosses of the rotor.
